(19) United States
(12) Patent Application Publication
(10) Pub. No.: US 2026/0315974 A1
(43) Pub. Date: Oct. 15, 2026

(54) FILTER ELEMENT FOR GAS FILTRATION

(71) Applicant: MANN+HUMMEL GmbH, Ludwigsburg (DE)

(72) Inventor: Daniel SCHMID, Sachsenheim (DE)

(21) Appl. No.: 19/681,233

(22) Filed: May 19, 2026

Related U.S. Application Data
(63) Continuation of application No. PCT/EP2024/080806, filed on Oct. 31, 2024.

(30) Foreign Application Priority Data
Nov. 20, 2023 (DE) 10 2023 132 245.1

(51) Int. Cl. B01D 46/00; B01D 46/10

(52) U.S. Cl. CPC B01D 46/0005; B01D 46/0049; B01D 46/10; B01D 2271/027; B01D 2279/50; B01D 2279/60

(57) ABSTRACT

A filter element has a filter medium body and a seal element arranged at a circumferential rim region of the filter medium body and extending at least across a partial length of the circumferential rim region of the filter medium body. The seal element has an undulated part that is provided with a first outer side of the seal element with a first undulated shape in a first axis direction of the filter medium body and further provided with a second outer side of the seal element with a second undulated shape in a second axis direction of the filter medium body. The first axis direction and the second axis direction are different from each other. The first outer side and the second outer side of the seal element adjoin each other. A filter device has a filter housing in which the filter element is received.

### CROSS-REFERENCE TO RELATED APPLICATIONS

This application is a continuation application of international application No. PCT/EP2024/080806 having an international filing date of Oct. 31, 2024, and designating the United States, the international application claiming a priority date of Nov. 20, 2023, based on prior filed German patent application No. 10 2023 132 245.1, the entire contents of the aforesaid applications being incorporated herein by reference to the fullest extent permissible.

### BACKGROUND OF THE INVENTION

The invention concerns a filter element that is used for gas filtration, for example, for an air filter, wherein the filter element comprises a filter medium body having a seal element arranged at its circumferential rim region.

DE 10 2017 222 591 A1 describes a plate filter element for an air conditioning device or for the combustion air of an internal combustion engine. The plate filter element comprises a filter body of folded filter material and a circumferentially closed seal attached to the filter body and extending at two opposed longitudinal sides of the filter body in an undulated shape. The undulated shape enables compressing or stretching of the seal, for example when being mounted in a filter housing, whereby tolerances may be compensated.

### Summary

It is an object of the invention to realize a filter element, comprising a filter medium body and a seal element arranged in the rim region, by simple constructive measures with a high error tolerance in order to facilitate the installation of the filter element in a receiving filter housing.

This object is solved according to the invention by a filter element for gas filtration, for example, for an air filter, comprising a filter medium body. comprising a seal element arranged at its circumferential rim region, wherein the seal element extends at least across a partial length of the circumferential rim region, wherein the seal element is formed in an undulated shape in two different axis directions of the filter medium body such that, in a first axis direction, a first outer side of the seal element is embodied in an undulated shape and, in a second axis direction, a second outer side of the seal element is embodied in an undulated shape, wherein the first and the second outer sides of the seal element, which are respectively undulated, adjoin each other.

The following detailed description provides expedient further features, advantages and developments.

The filter element according to the invention is used for gas filtration, for example, for an air filter in the intake manifold of an internal combustion engine or for filtration of air to be supplied to a vehicle interior. The filter element may be used also for liquid filtration, as needed. The filter element comprises a filter medium body, through which the fluid to be filtered is guided and at which the filtration takes place, and further comprises a seal element arranged in the rim region of the filter medium body, by means of which, in an installed position of the filter element in a housing, a flow-tight connection to the contacting inner wall regions of the filter housing is provided. In the installed position, the seal element separates in a flow-tight manner the clean side, or outflow side, of the filter element from the raw side, or inflow side.

The seal element extends circumferentially around the filter medium body and surrounds it completely. In principle, it is however sufficient that the seal element extends at least at one side, optionally at several sides of the filter medium body, without extending completely circumferentially around. In the latter case, the seal element extends across a partial length of the circumferential rim region at the filter medium body.

Along a seal section, the seal element is configured in an undulated shape in two different axis directions of the filter medium body. In the seal section in question, the seal element is thus configured in an undulated shape in a first axis direction at one of its outer sides and, moreover, is also configured in an undulated shape in a second axis direction at a second outer side of the seal element in the same seal section. The first and the second outer sides of the seal element, which are each configured in an undulated shape, adjoin each other. This double undulated configuration of the seal element has the advantage that an undulated shape is provided in two different axis directions and, correspondingly, an improved tolerance compensation in these two axis directions may be realized by means of expanding or stretching of the seal element upon installation in a receiving filter housing. Due to the double undulated configuration of the seal element, a tolerance compensation with compression or stretching of the seal element in two different axis directions is accordingly possible. The double undulated configuration relates in this context to the same seal section of the seal element which is embodied in an undulated shape in two different axis directions.

It is sufficient in principle that the undulated seal section extends only at one side of the filter medium body. In this context, it may be expedient when the seal element is configured to extend circumferentially, for example to extend completely circumferentially, but only one side is configured to be undulated while the further sides of the seal element are configured without any undulation and are continuously smooth. Furthermore, it is possible that the seal element does not extend completely circumferentially but covers only one side of the filter medium body or extends only across two or more sides of the filter medium body without extending completely circumferentially, wherein only one part of the seal element comprises an undulated shape. Finally, it is also possible that the seal element extends across several sides of the filter medium body or is configured to extend completely circumferentially and is configured with a double undulated shape across its entire length or across a partial length.

According to an embodiment, an undulated outer side of the seal element is positioned radially relative to the flow direction of the filter medium body. The flow direction of the filter medium body may be referred to as axial direction or main axial direction, wherein the radial outer side of the seal element, in relation to the axial direction or flow direction, faces in radial direction outwardly and thus faces away from the filter medium body. The radially inner side of the seal element, with which the seal element contacts directly the filter medium body, is for example configured without any undulation and instead is designed to extend straight. Thus, the seal element comprises in radial direction an alternating thickness in the undulated shape, when considering the longitudinal extension of the seal element along the outer side of the filter medium body.

According to a further embodiment, the second undulated outer side of the seal element is positioned, in relation to the flow direction or axial direction, axially outwardly and adjoins immediately the radially outwardly positioned undulated side of the seal element. The axial undulated shape is located for example only at an axial outer side of the seal element while the oppositely positioned outer side extends straight or has a straight surface. As an alternative, it is however also possible that both oppositely positioned axial outer sides of the seal element are formed with an undulated shape. In case of only one undulated axial outer side, the latter is for example positioned so as to face away from the closest inflow side or outflow side of the filter medium body. As an alternative, it is also possible that the axial outer side of the seal element which is facing the closest inflow side or outflow side of the filter medium body is of an undulated configuration.

According to a further embodiment, the filter medium body and the filter element are configured in a cuboid shape, respectively. The seal element extends for example along all four outer sides of the cuboid and is designed to extend circumferentially, wherein the undulated shape for example extends only across a partial stretch of the seal element, for example, only at one of the four outer sides of the cuboid.

In principle, the double undulated shape of the seal element may also be applied to filter elements and filter medium bodies with a non-cuboid shape, for example, at the axial end face of a hollow-cylindrical filter element.

According to a further embodiment, the seal element immediately adjoins the inflow side or the outflow side of the filter medium body. Furthermore, it may be expedient that the undulated part of the seal element extends only across a partial axial height of the filter medium body. For example, two parallel extending seal elements, which are arranged to extend circumferentially at the filter medium body, may be arranged adjacent to the inflow side and adjacent to the outflow side of the filter medium body. It is sufficient that only one of the circumferential seal elements comprises a double undulated section while the second seal element, on the other hand, is configured without any undulation. Furthermore, it is however also possible that both seal elements each have a double undulated section or that one seal element is configured with a double undulated shape and the second seal element is configured with a single undulated shape.

According to yet another embodiment, the seal element is applied by a casting method onto the rim region of the filter medium body.

The filter medium body is for example designed as a folded filter, wherein the folds are aligned in such a way that the fold sidewalls extend parallel to the flow direction.

### BRIEF DESCRIPTION OF THE DRAWINGS

Further advantages and expedient embodiments may be taken from the following detailed description, and from the accompanying drawings.

FIG. 1 shows in a perspective view a cuboid filter element for gas filtration, comprising a filter medium body and a seal element, which is of a double undulated configuration in sections, at the outer side of the filter medium body.

FIG. 2 shows the circumferentially extending seal element with the undulated section in an individual illustration.

FIG. 3 shows the seal element in a side view.

FIG. 4 shows the seal element in a plan view.

FIG. 5 shows the filter element in a side view.

FIG. 6 shows the filter element in a plan view.

FIG. 7 shows in a perspective view a filter device with a two-part filter housing, comprised of a housing base body and a housing attachment body, for receiving a filter element with a circumferentially extending undulated seal element.

FIG. 8 shows the filter device with the housing base body and the housing attachment body as well as the filter element in a perspective exploded illustration shown from above.

FIG. 9 shows the filter device in a perspective exploded illustration shown from below.

FIG. 10 shows the filter device in a vertical section.

FIG. 11 shows an enlarged detail taken from FIG. 10.

FIG. 12 shows an embodiment variant of the filter device in a perspective exploded illustration shown from above.

FIG. 13 shows the filter device of FIG. 12 in a perspective exploded illustration shown from below.

FIG. 14 shows a further embodiment variant of the filter device in a perspective exploded illustration shown from above.

FIG. 15 shows the filter device of FIG. 14 in a perspective exploded illustration shown from below.

FIG. 16 shows a further embodiment variant of the filter device in a perspective exploded illustration shown from below.

FIG. 17 shows the filter device of FIG. 16 in a perspective exploded illustration shown from below.

In the drawing figures, the same or similar components are provided with the same or similar reference characters.

### DETAILED DESCRIPTION

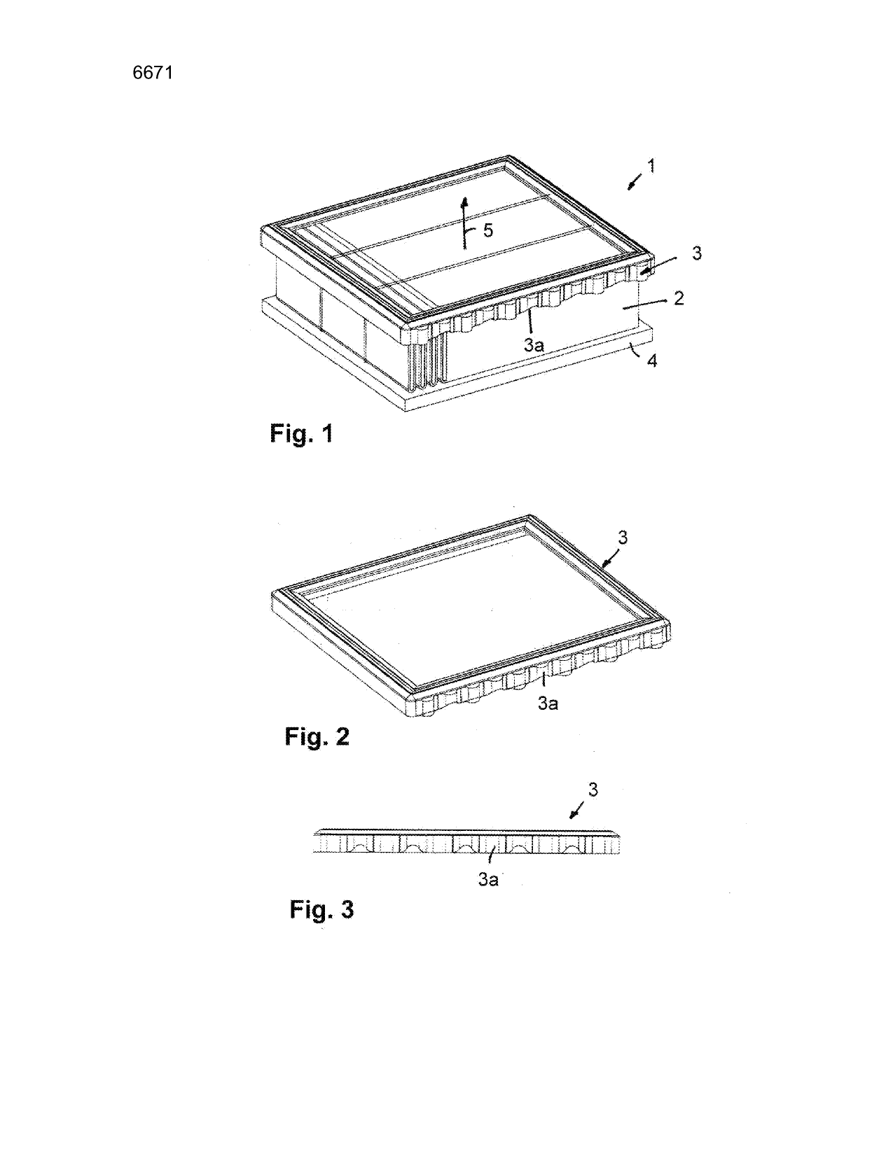

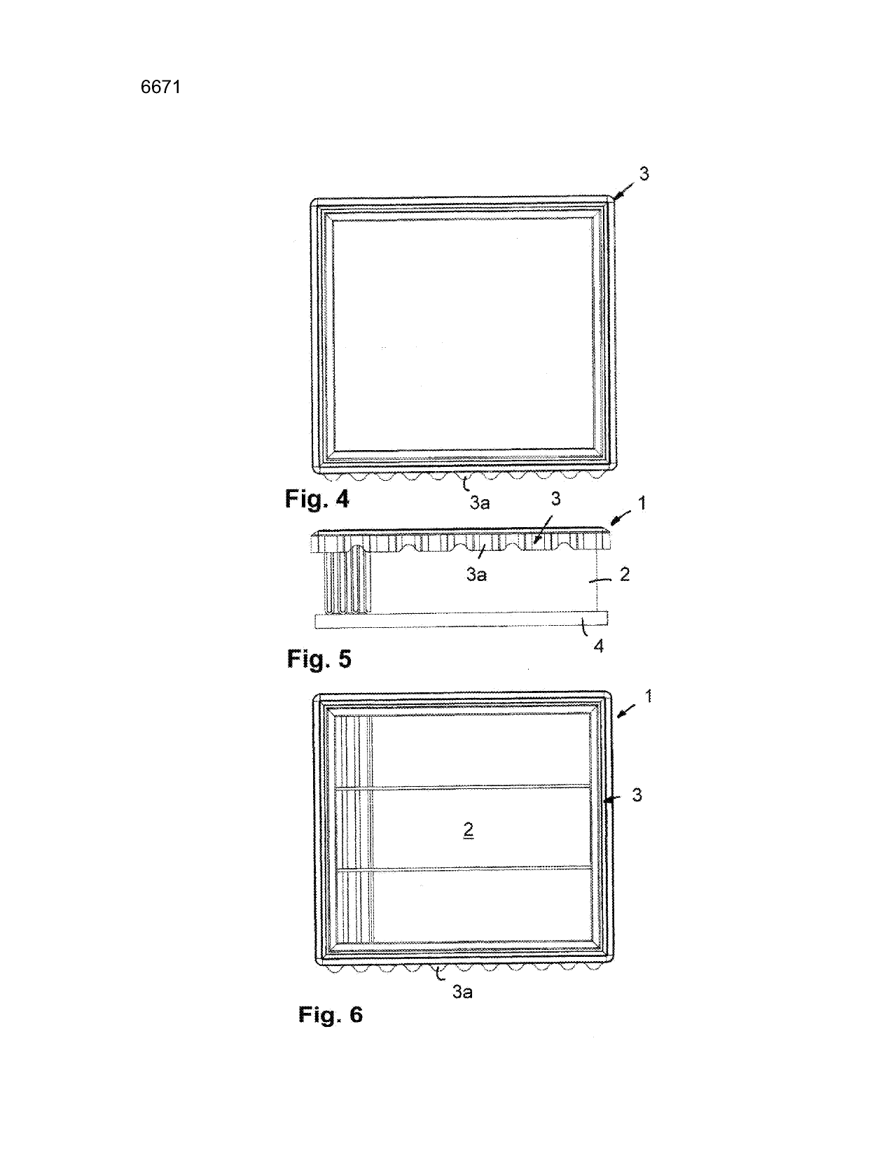

The filter element 1 illustrated in the drawing figures is of a cuboid shape and comprises a filter medium body 2 configured as a folded filter and further comprises two circumferentially extending seal elements 3, 4 which extend along the outer side of the filter medium body 2 and are connected to the filter medium body 2. The flow direction of the filter medium body 2 is indicated by arrow 5. The lower side of the filter medium body 2 in FIG. 1 forms correspondingly the inflow, or raw side, the top side forms the outflow side, or clean side. The filter folds of the filter medium body 2 are aligned in such a way that the fold sidewalls extend parallel to the flow direction 5.

The seal elements 3, 4 are applied by a casting process onto the rim region of the filter medium body 2. Both seal elements 3, 4 which extend parallel to each other are arranged so as to extend circumferentially around the filter medium body 2. The first seal element 3 is located directly adjacent to the outflow side, the second seal element 4 is located directly adjacent to the inflow side of the filter medium body 2. Both seal elements 3, 4 project radially, in relation to the flow direction 5, past the circumferentially extending outer side of the filter medium body 2.

One side of the rectangular frame-shaped seal element 3 that is arranged adjacent to the outflow side of the filter medium body 2 is configured in a double undulated configuration while the three other sides of this seal element 3 are straight and embodied without any undulation. The double undulated section 3a of the seal element 3 enables in two axis directions a compression and stretching of the seal element section 3a so that an improved tolerance compensation is provided, for example when installing the filter element 1 in a receiving filter housing. On the one hand, the seal element section 3a comprises an undulated shape in radial direction, in relation to the flow direction 5. Accordingly, the radial distance, for example, from the outer side of the filter medium body 2 to the radial outer side of the undulated seal element section 3a, varies along the length of the seal element section 3a. The undulated shape is applied only to the radial outer side of the seal element section 3a but not to the radially inwardly positioned side with which the seal element 3 contacts directly the filter medium body 2. The wave troughs of the radial undulated shape are located radially at the same height as the outer sides of the remaining non-undulated sections of the seal element 3.

The second undulated shape of the seal element section 3a extends in axial direction, also in relation to the flow direction 5. As may be seen, for example, in FIGS. 3 and 5, the side of the seal element section 3a positioned axially at the bottom and facing away from the outflow side of the filter medium body 2 is provided with an undulated shape while the side of the section 3a positioned at the top and facing the outflow side is straight.

The extension between wave trough and wave peak lies in case of the radial undulated shape in a range of magnitude between 10% and 50% of the maximum radial thickness of the section 3a. The axial extension between wave trough and wave peak lies in a value range between 10% and 50% of the maximum axial extension of the section 3a. The number of waves in the axial direction is only half as many as the number of waves in the radial direction.

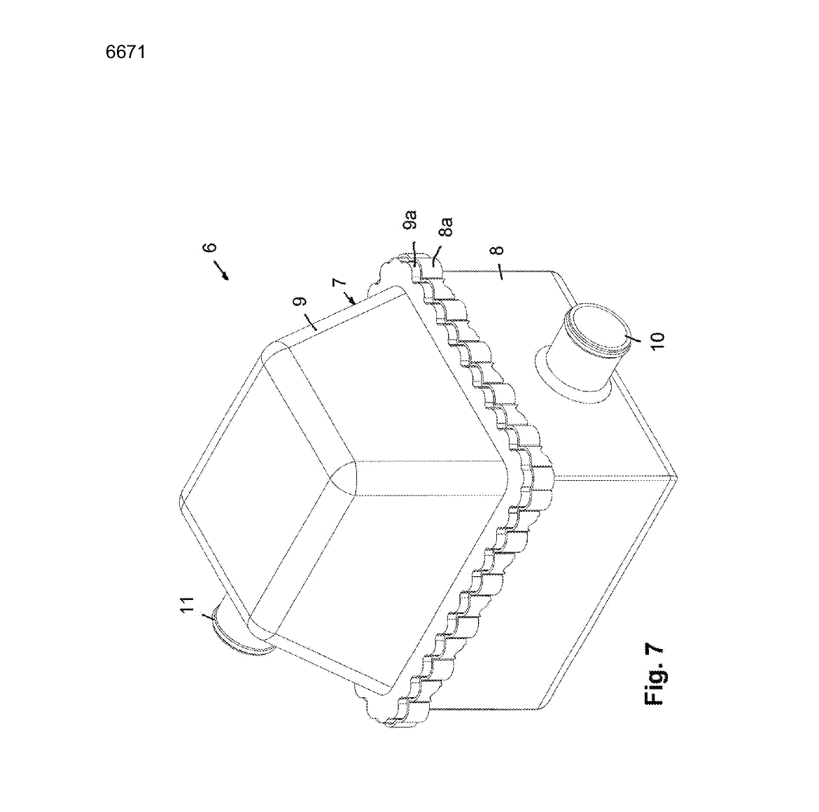

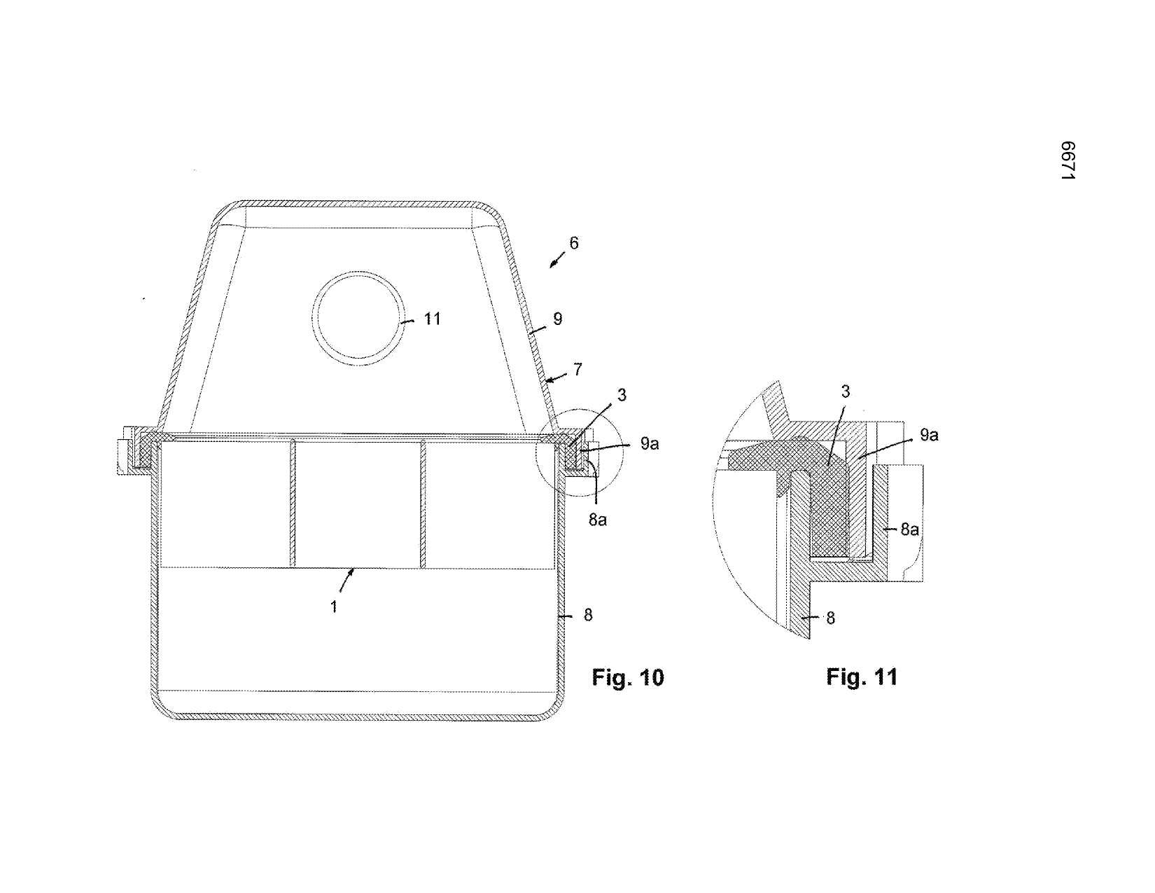

In FIGS. 7 to 11, a filter device 6 with a two-part filter housing 7, comprised of a housing base body 8 and a housing attachment body 9, for receiving a filter element 1 is illustrated. At the housing base body 8 as well as at the housing attachment body 9, there is a respective circumferentially extending undulated groove-shaped section 8a and 9a, respectively, which is matched to the contour of the undulated circumferentially extending seal element 3 at the filter medium body 2. The filter element 1 with the filter medium body 2 is embodied, as in the first embodiment, with a cuboid shape but only one circumferentially extending seal element 3 is provided that is embodied across the entire circumference with a double undulated configuration. The circumferentially extending undulated sections 8a and 9a at the housing base body 8 and at the housing attachment body 9 are matched to the undulated shape of the seal element 3 and project past the outer side of the housing base body 8 and housing attachment body 9, respectively. This embodiment makes it possible to insert the filter medium body 2 into the housing base body 8 and to suspend the circumferentially extending seal element 3 with form fit in the undulated section 8a at the housing base body 8. When placing the housing attachment body 9 on the housing base body 8, the undulated section 9a of the housing attachment body 9 engages across the undulated section 8a at the housing base body 8 including the inserted undulated seal element 3. The filter element 1 is therefore safely received in the filter housing 7 and is positioned in this manner flow-tightly in the filter housing 7 such that the fluid to be purified is forced to take the path through the filter element 1 and bypass flows are prevented. At the housing base body 8 and at the housing attachment body 9, flow sockets 10, 11 are formed by means of which the raw fluid is introduced and the purified fluid is discharged.

In analogy to the undulated seal element 3, the undulated section 8a at the housing base body 8 comprises an undulated shape in two directions orthogonal to the circumferential extension of the seal element 3. Correspondingly, a form-fit reception of the seal element section 3a is provided in the undulated section 8a at the housing base body 8 in two directions that are orthogonal to each other.

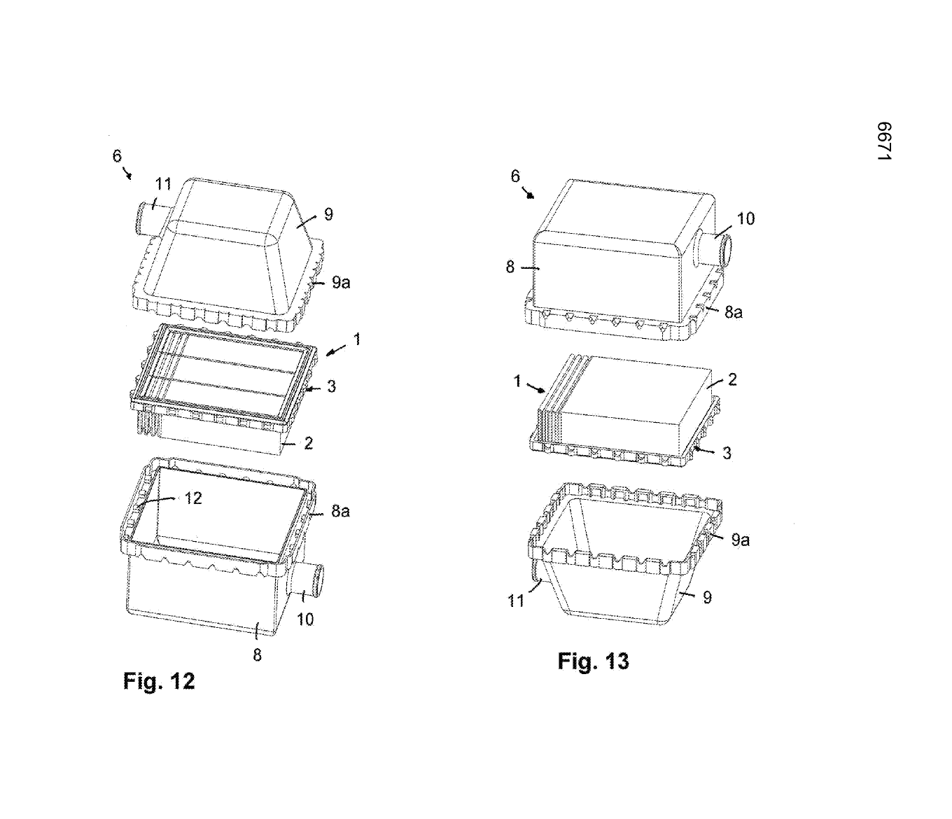

In the further embodiments according to FIGS. 12 to 17, filter devices 6 are illustrated which also comprise a two-part filter housing 7, comprising a housing base body 8 and a housing attachment body 9, and further comprise an inserted filter element 1. In relation to the same or similar components, reference is being had to FIGS. 7 to 11.

According to FIGS. 12 and 13, the undulated section 8a at the housing base body 8 is provided with a substantially smooth outer wall. At the inner side, the undulated section 8a comprises cam-shaped projections 12 which correspond with radial wave troughs at the undulated seal element 3. When the filter element 1 is inserted, the cam-shaped projections 12 at the inner side of the undulated section 8a engage the wave troughs at the undulated seal element 3.

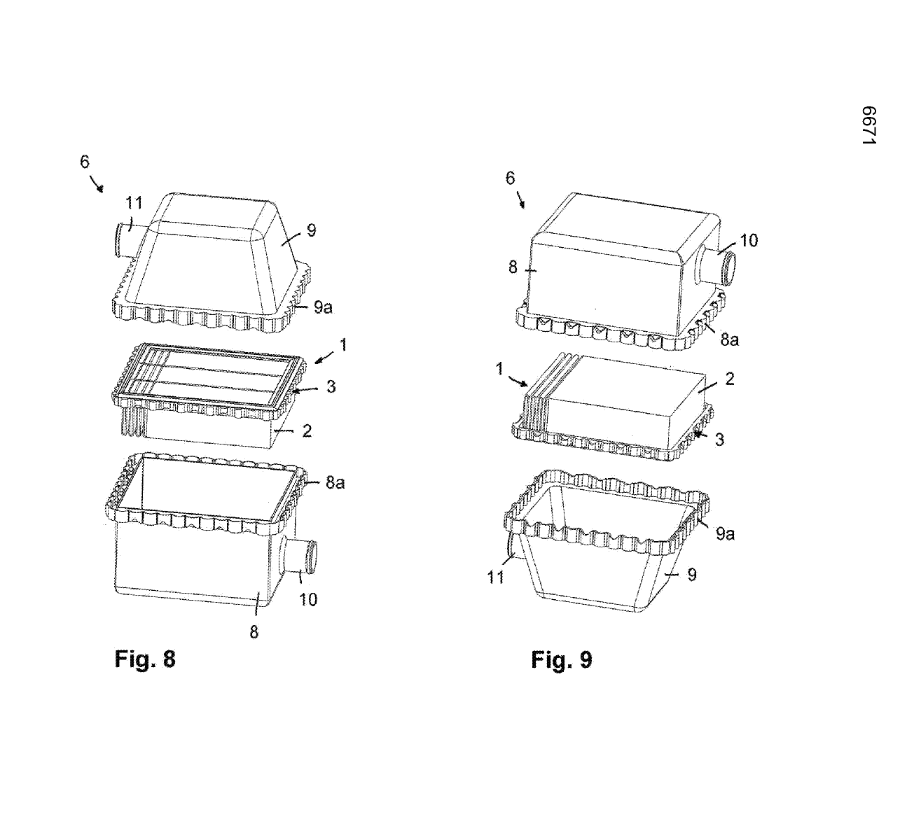

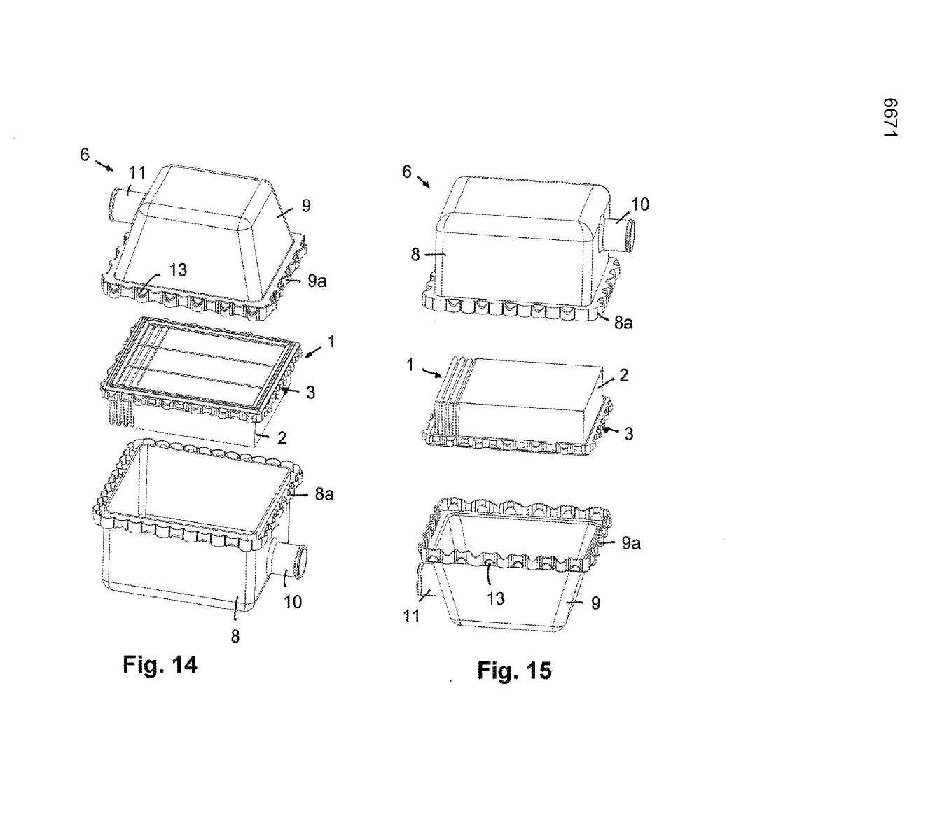

In FIGS. 14 and 15, the undulated section 8a at the housing base body 8 is configured as in the embodiment according to FIGS. 8 and 9. The undulated section 9a at the housing attachment body 9 comprises in addition at the upper axial rim, by means of which the connection to the sidewall of the housing attachment body 9 is produced, cutouts 13 into which the seal material of the seal element 3 may expand when placing the housing attachment body 9 on the housing base body 8.

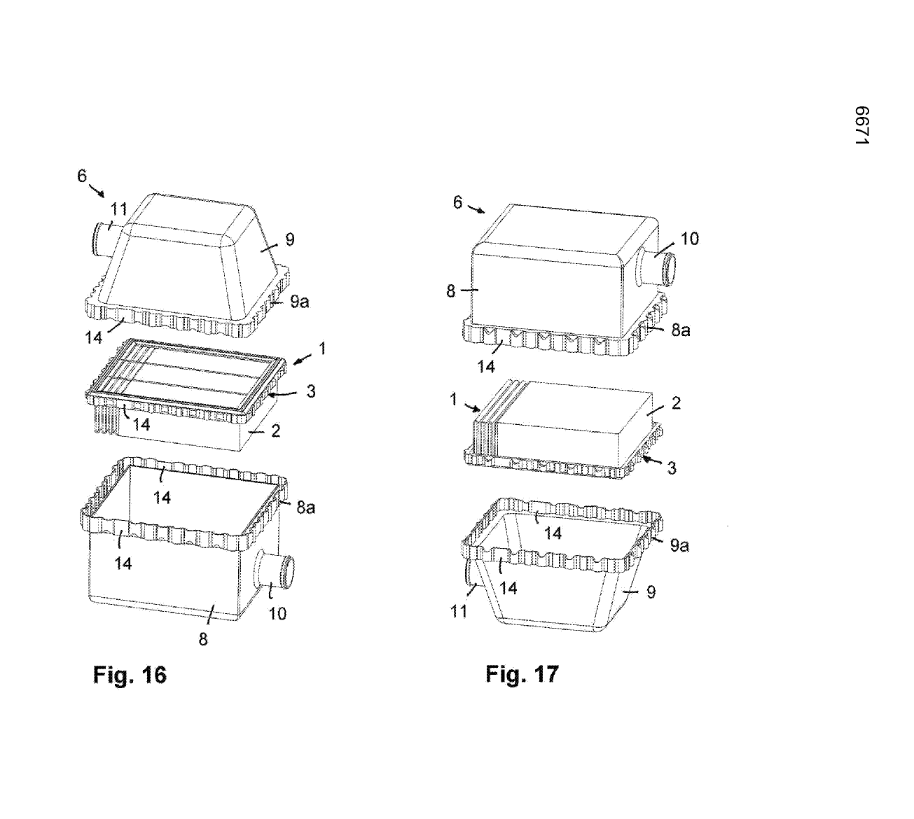

In FIGS. 16 and 17, the undulated section 8a at the housing base body 8, the undulated section 9a at the housing attachment body 9, and the undulated seal element 3 are each provided with a respective smooth section 14 at both opposed longitudinal sides in the otherwise undulated course. By means of the smooth walled section 14, an unequivocal installation position is provided when assembling housing base body 8, filter element 1, and housing attachment body 9.

That which is claimed is:

1. A filter element comprising:
a filter medium body;
a seal element arranged at a circumferential rim region of the filter medium body and extending at least across a partial length of the circumferential rim region of the filter medium body;
wherein the seal element comprises an undulated part, wherein the undulated part comprises a first outer side of the seal element comprising a first undulated shape in a first axis direction of the filter medium body and further comprises a second outer side of the seal element comprising a second undulated shape in a second axis direction of the filter medium body, wherein the first axis direction and the second axis direction are different from each other;
wherein the first outer side and the second outer side of the seal element adjoin each other.

2. The filter element according to claim 1, wherein one of the first outer side and the second outer side of the seal element is positioned radially to a flow direction of the filter medium body.

3. The filter element according to claim 1, wherein one of the first outer side and the second outer side of the seal element is an axially outwardly positioned outer side in relation to a flow direction of the filter medium body.

4. The filter element according to claim 3, wherein the axially outwardly positioned outer side is positioned at a top of the seal element or at a bottom of the seal element in relation to the flow direction, and wherein a third outer side of the seal element oppositely positioned to the axially outwardly positioned outer side is straight.

5. The filter element according to claim 1, wherein at least one of the filter medium body and the filter element comprises a cuboid configuration.

6. The filter element according to claim 1, wherein the undulated part of the seal element extends only across a partial length of the circumferential rim region.

7. The filter element according to claim 6, wherein the filter medium body is a cuboid filter medium body, and wherein the undulated part of the seal element extends only across one side of the circumferential rim region of the cuboid filter medium body.

8. The filter element according to claim 6, wherein the seal element is arranged circumferentially around the filter medium body and comprises a non-undulated part adjoining the undulated part of the seal element.

9. The filter element according to claim 1, wherein the undulated part of the seal element extends completely around the circumferential rim region of the filter medium body.

10. The filter element according to claim 1, wherein the seal element is cast onto the circumferential rim region of the filter medium body.

11. The filter element according to claim 1, wherein the undulated part of the seal element extends only across a partial axial height of the filter medium body.

12. A filter device comprising:
the filter element according to claim 1; and
a filter housing configured to receive the filter element.

13. The filter device according to claim 12, wherein the filter housing comprises one or more undulated groove-shaped sections comprising a shape that is complementary to the undulated part of the sealing element, and wherein the one or more undulated groove-shaped sections extend at least partially circumferentially around a rim of the filter housing and are configured to receive the undulated part of the seal element.

14. The filter device according to claim 13, wherein the filter housing comprises a housing base body and further comprises a housing attachment body configured to be positioned on the housing base body, and wherein the housing base body and the housing attachment body each comprise one of the one or more undulated groove-shaped sections.

15. The filter device according to claim 14, wherein the undulated groove-shaped section of the housing attachment body is configured to be inserted into the undulated groove-shaped section of the housing base body.
